(19) United States
(12) Patent Application Publication
(10) Pub. No.: US 2004/0002956 A1
(43) Pub. Date: Jan. 1, 2004

(54) Approximate query processing using multiple samples

(75) Inventors: Surajit Chaudhuri, Redmond, WA (US); Gautam Das, Redmond, WA (US); Vivek Narasayya, Redmond, WA (US)

Correspondence Address: WATTS, HOFFMANN, FISHER & HEINKE CO., L.P.A., Ste. 1750, 1100 Superior Ave., Cleveland, OH, 44114, US

(73) Assignee: Microsoft Corporation

(21) Appl. No.: 10/185,149

(22) Filed: Jun. 28, 2002

(51) Int. Cl. G06F 17/30

(52) U.S. Cl. 707/2

(57) ABSTRACT

A method for estimating the result of an aggregation query on a database using multiple sample tables. A given workload is divided into a set of workload partitions that include queries from the workload. A set of sample tables are constructed. Samples for each sample table are selected to reduce an estimation error for one of the partitions of queries. The most appropriate sample table in the set of sample tables is identified for a given query. The given query is executed on the most appropriate sample table and an estimated result for the given query is returned.

### TECHNICAL FIELD

The invention relates to the field of database systems. More particularly, the invention relates to a method of estimating the result of an aggregate query based on a database workload using multiple sample tables.

### BACKGROUND OF THE INVENTION

In recent years, decision support applications such as On Line Analytical Processing (OLAP) and data mining tools for analyzing large databases have become popular. A common characteristic of these applications is that they require execution of queries involving aggregation on large databases, which can often be expensive and resource intensive. Therefore, the ability to obtain approximate answers to such queries accurately and efficiently can greatly benefit these applications. One approach used to address this problem is to use precomputed samples of the data instead of the complete data to answer the queries. While this approach can give approximate answers very efficiently, it can be shown that identifying an appropriate precomputed sample that avoids large errors on any arbitrary query is virtually impossible, particularly when queries involve selections, GROUP BY and join operations. To minimize the effects of this problem, previous studies have proposed using the workload to guide the process of selecting samples. The goal is to pick a sample that is tuned to the given workload and thereby insure acceptable error at least for queries in the workload.

Previous methods of identifying an appropriate precomputed sample suffer from significant drawbacks. The proposed solutions use ad-hoc schemes for picking samples from the data, thereby resulting in degraded quality of answers. The previously proposed solutions do not attempt to formally deal with uncertainty in the expected workload, i.e., when incoming queries are similar but not identical to the given workload. Previous methods ignore the variance in the data distribution of the aggregated column(s).

The complexity and diversity of both workloads and database schemas in some applications make it difficult for a single sample table of a database to provide adequate quality and performance. Acceptable quality may require a large sample table that is detrimental to performance. A smaller table increases performance, but reduces quality.

One type of method for selecting a sample is based on weighted sampling of the database. Each record t in the relation R to be sampled is tagged with a frequency fₜ corresponding to the number of queries in the workload that select that record. Once the tagging is done, an expected number of k records are selected in the sample, where the probability of selecting a record t (with frequency fₜ) is k*(fₜ/Σᵤfᵤ) where the denominator is the sum of the frequencies of all records in R. Thus, records that are accessed more frequently have a greater chance of being included inside the sample. In the case of a workload that references disjoint partitions of records in R with a few queries that reference large partitions and many queries that reference small partitions, most of the samples will come from the large partitions. Therefore there is a high probability that no records will be selected from the small partitions and the relative error in using the sample to answer most of the queries will be large.

Another sampling technique that attempts to address the problem of internal variance of data in an aggregate column focuses on special treatment for “outliers,” records that contribute to high variance in the aggregate column. Outliers are collected in a separate index, while the remaining data is sampled using a weighted sampling technique. Queries are answered by running them against both the outlier index as well as the weighted sample. A sampling technique called “Congress” tries to simultaneously satisfy a set of GROUP BY queries. This approach, while attempting to reduce error, does not minimize any well-known error metric.

### SUMMARY

The present application concerns a method for estimating the result of an aggregation query on a database using multiple sample tables. In the method a given workload is divided into a set of workload partitions that include queries from the workload. A set of sample tables are constructed. Samples for each sample table are selected to reduce an estimation error for one of the partitions of queries. The most appropriate sample table in the set of sample tables is identified for a given query. The given query is executed on the most appropriate sample table and an estimated result for the given query is returned.

In one embodiment, a measure of similarity between queries is used to partition a given workload into multiple partitions. The similarity between queries may correspond to the similarity of WHERE clauses or GROUP-BY columns in the queries.

A clustering algorithm may be used to partition the workload into multiple partitions. Each partition contains queries that are similar to each other. Each partition may be used to build separate sample table. In one embodiment, the sample tables are built using stratified random sampling. In one embodiment, the method determines at runtime the most appropriate sample table to use for rewriting and executing an incoming query.

In one embodiment, the number and sizes of sample tables are determined by the method. The number and sizes of sample tables may be based on physical constraints of the database. In one embodiment, total available space for sample tables and upper limits on execution times of queries are constraints that determine the number and sizes of the sample tables.

In one embodiment, a centroid query is calculated for each workload partition. The most appropriate sample table is identified by comparing the given query to the centroid queries of the workload partitions. The sample table that corresponds to a workload partition having a centroid query that is most similar to the given query is selected.

### BRIEF DESCRIPTION OF THE DRAWINGS

FIG. 1 illustrates an operating environment for estimating a result to an aggregate query on a database by executing the query on a sample that has been constructed to minimize error over an expected workload;

FIG. 2 illustrates a database system suitable for practice of an embodiment of the present invention;

FIG. 3 is a block diagram of a database system depicting a preprocessing module that builds multiple sample tables and a query processing module the rewrites and executes given queries on a most appropriate sample table in accordance with an embodiment of the present invention;

FIG. 4 is a Venn diagram depiction of random sampling;

FIG. 5 is a Venn diagram depiction of stratified sampling;

FIG. 6 is a Venn diagram depiction of stratified sampling using multiple sample tables;

FIG. 7 is a flow chart that illustrates a preprocessing module; and

FIG. 8 is a flow chart that illustrates a query processing module.

### DETAILED DESCRIPTION

Estimating a result to an aggregate query by building multiple sample tables that have each been constructed to minimize error for a group of similar queries in the workload and executing the aggregate query on the most appropriate sample table increases the accuracy of the estimate.

Exemplary Environment for Practicing the Invention

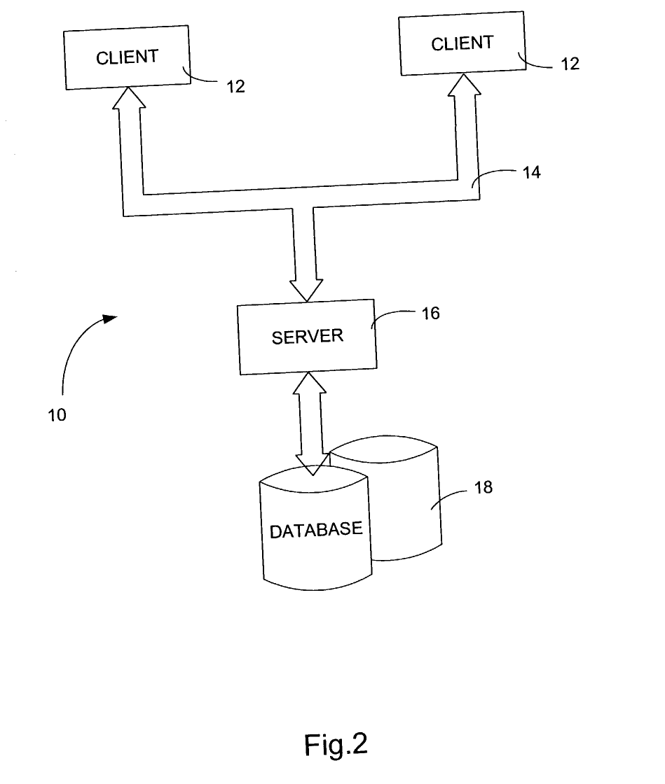

FIG. 2 illustrates an example of a suitable client/server system 10 for use with an exemplary embodiment of the invention. The system 10 is only one example of a suitable operating environment for practice of the invention. The system includes a number of client computing devices 12 coupled by means of a network 14 to a server computer 16. The server 16 in turn is coupled to a database 18 that is maintained on a possibly large number of distributed storage devices for storing data records. The data records are maintained in tables that contain multiple number of records having multiple attributes or fields. Relations between tables are maintained by a database management system (DBMS) that executes on the server computer 16. The database management system is responsible for adding, deleting, and updating records in the database tables and also is responsible for maintaining the relational integrity of the data. Furthermore, the database management system can execute queries and send snapshots of data resulting from those queries to a client computer 12 that has need of a subset of data from the database 18.

Data from the database 18 is typically stored in the form of a table. If the data is “tabular”, each row consists of a unique column called “case id” (which is the primary key in database terminology) and other columns with various attributes of the data.

Computer System

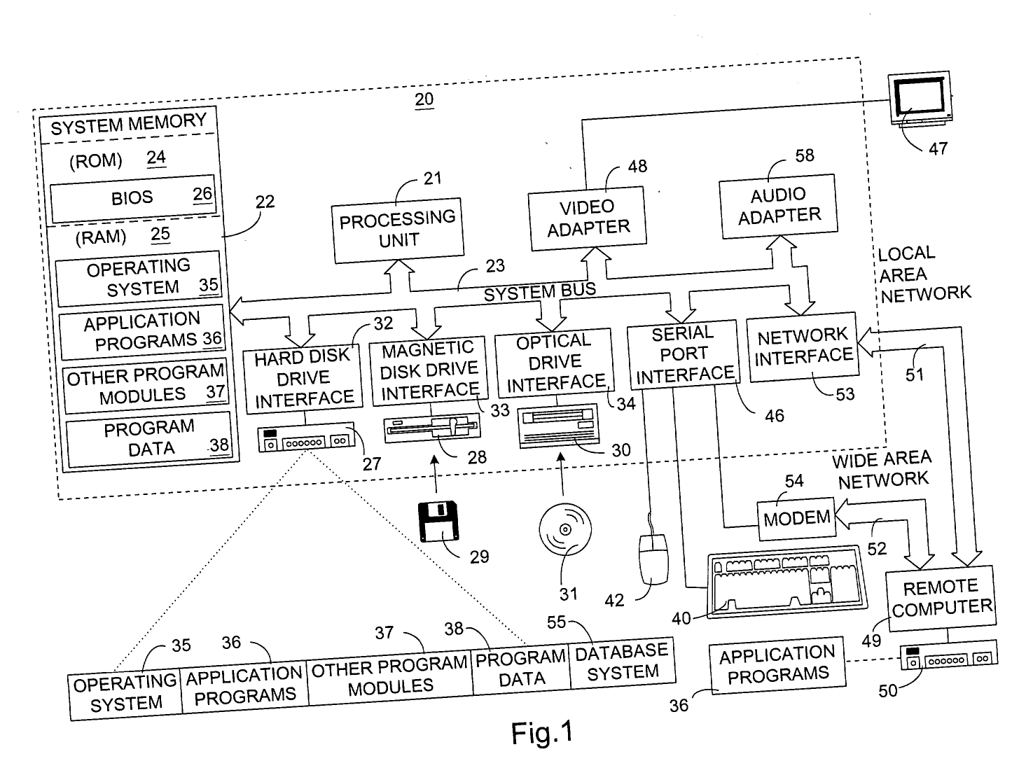

With reference to FIG. 1 an exemplary embodiment of the invention is practiced using a general purpose computing device 20. Such a computing device is used to implement both the client 12 and the server 16 depicted in FIG. 2. The device 20 includes one or more processing units 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures.

The system memory includes read only memory (ROM) 24 and random access memory (RAM) 25. A basic input/output system 26 (BIOS), containing the basic routines that helps to transfer information between elements within the computer 20, such as during start-up, is stored in ROM 24.

The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide nonvolatile storage of computer readable instructions, data structures, program modules and other data for the computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROM), and the like, may also be used in the exemplary operating environment.

A number of program modules may be stored on the hard disk, magnetic disk 29, optical disk 31, ROM 24 or RAM 25, including an operating system 35, one or more application programs 36, other program modules 37, and program data 38. A user may enter commands and information into the computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB). A monitor 47 or other type of display device is also connected to the system bus 23 via an interface, such as a video adapter 48. In addition to the monitor, personal computers typically include other peripheral output devices (not shown), such as speakers and printers.

The computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets and the Internet.

When used in a LAN networking environment, the computer 20 is connected to the local network 51 through a network interface or adapter 53. When used in a WAN networking environment, the computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used.

Overview of Approximate Query Processing

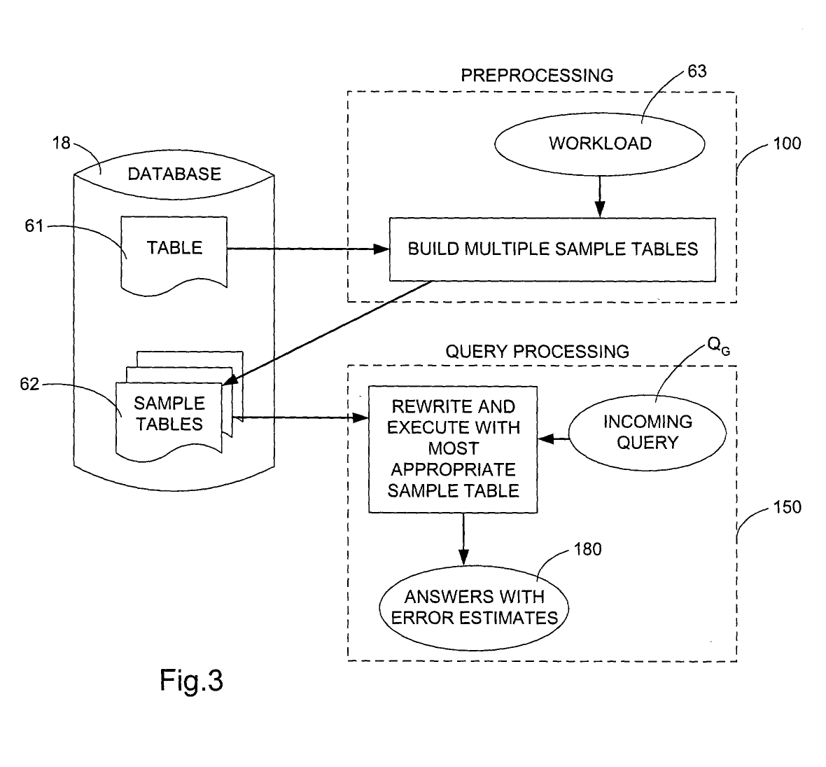

Referring to FIG. 3, a preprocessing module 100 that accesses one or more database tables 61 and constructs multiple sample tables 62 is shown. This disclosure presents a method for more accurately approximating the result of an aggregation query, such as COUNT, SUM and average. A given database workload 63 is used to construct multiple sample tables 62. A query processing module 150 matches an incoming query with a most appropriate sample table, rewrites an incoming query Q_{G} to execute on the most appropriate sample table, if appropriate, and then executes the query on the most appropriate sample table to provide an answer set. An error estimate may also be provided along with the answer. To arrive at the answer set, the value(s) of the aggregate column(s) are first scaled up by multiplying with the scaling factor and then aggregated.

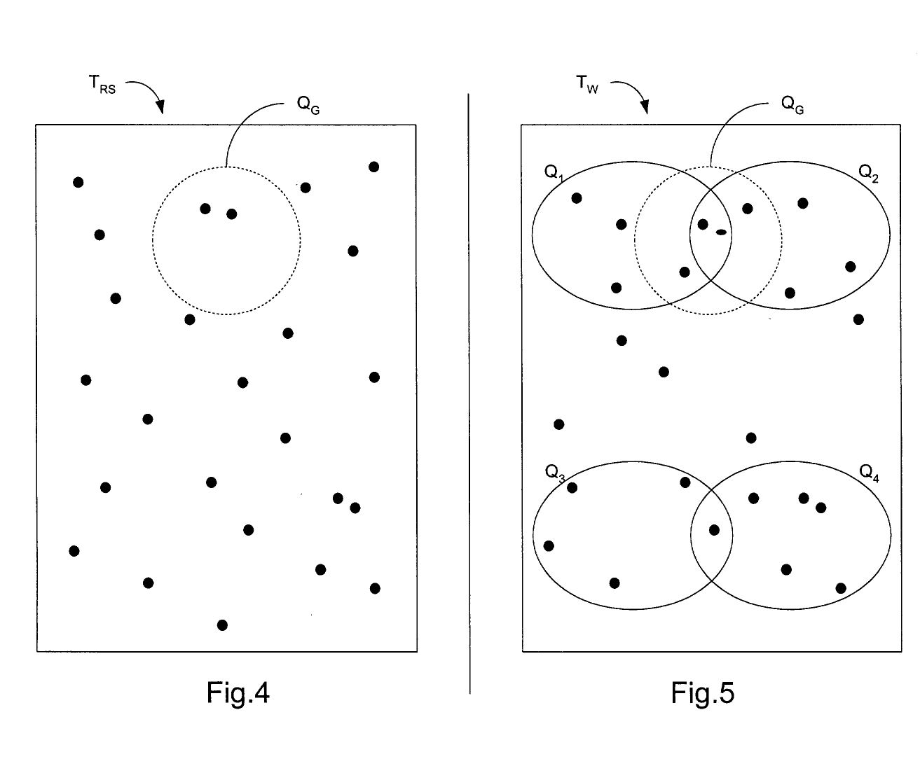

Referring to FIG. 4, previous schemes for approximating aggregation used random sampling of the database tables to create a sample table. A query is then run on the sample table to obtain an approximate result. As is illustrated by FIG. 4, the problem with using random sampling for approximate query processing is that a given aggregation query, may hit only a small number or no records in the sample table. For example, FIG. 4 illustrates that given query Q_{G} may hit only a small number of records in the sample table T_{RS} produced by random sampling, even though executing the aggregation query on the database may hit many records. As is apparent, random sampling may result in a very inaccurate approximation to an aggregation query.

U.S. patent application Ser. No. 09/861,960 to Chaudhuri et al, entitled “Optimization Based Method for Estimating the Results of Aggregate Queries” (“the '960 application”) is incorporated herein by reference in its entirety. The '960 patent application discloses a method of estimating the result of an aggregation query on a database. The method of the '960 patent uses information about a given workload to select samples for a sample table. For example, samples may be taken more heavily from groups of records in the database that are often accessed (“hot areas”) by queries in the workload. As a result, an approximation of a given or incoming query that is similar to the queries in the workload is more accurate. FIG. 5 illustrates a sample table T_{W} created using a workload that included queries Q₁, Q₂, Q₃, and Q₄ that include only selection conditions. FIG. 5 uses selection queries as examples because they can be represented as simply as ovals in the figure. The disclosed method is not limited to queries that include only selection conditions. For example, the disclosed method may be used to approximate answers to queries with GROUP BY and/or some JOIN operations, such as foreign key joins. In the example shown by FIG. 5, the majority of the records in the sample table T_{W} are records that were accessed by the queries in the workload (“hot areas”). A given query Q_{G} that is similar to queries Q₁ and Q₂ will hit many of the records in the sample table T_{W} in the regions defined by queries Q₁ and Q₂. As a result, the accuracy of the approximation is improved.

The present disclosure builds upon the method disclosed by the '960 application by using the workload to build multiple sample tables and executing a given query on the most appropriate sample table for the given query. In approximate query processing, it is often the case that time is expensive, but space is cheap. That is, it is important that an approximated result to a given query be returned quickly, but there is plenty of space for samples. However, the size of a sample table is limited because a larger sample table increases the time required to return an approximated result to a given query.

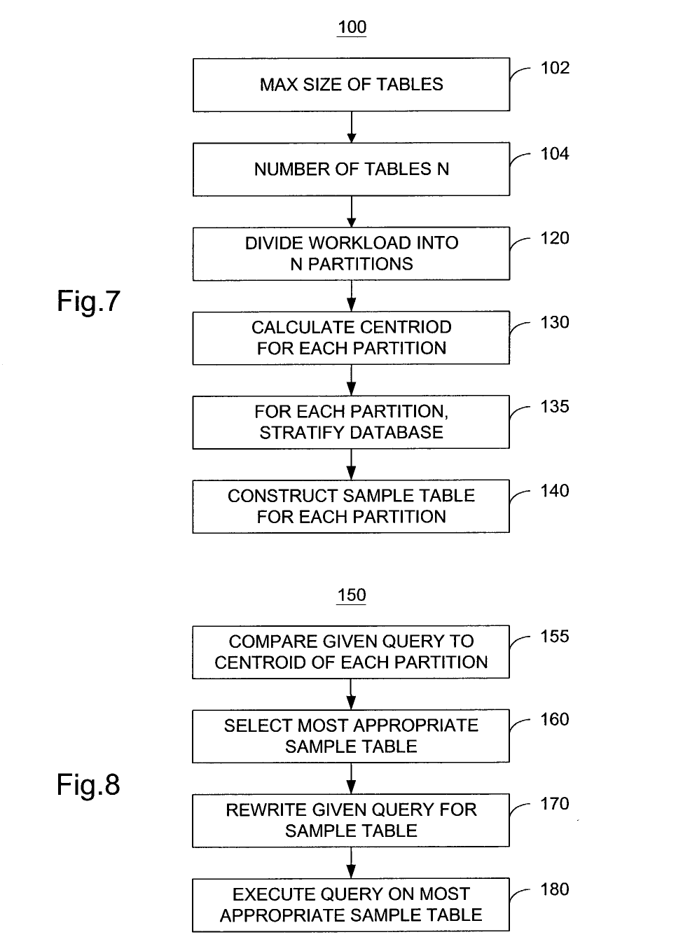

As can be seen from FIG. 5, a given workload may include groups of similar queries. In FIG. 5, queries Q₁ and Q₂ are similar and queries Q₃ and Q₄ are similar queries. Referring to FIGS. 3 and 7, in a preprocessing phase the disclosed method divides 120 a given workload into a set of workload partitions that each include similar queries and constructs 140 a set of corresponding sample tables. In the exemplary embodiment, the records selected for each sample table are records often accessed by queries in a corresponding workload partition. Referring to FIGS. 5 and 8, in a query processing phase 150 a most appropriate sample table is identified 160 for a given query. The given approximation query is rewritten 170 and executed 180 on the most appropriate sample table.

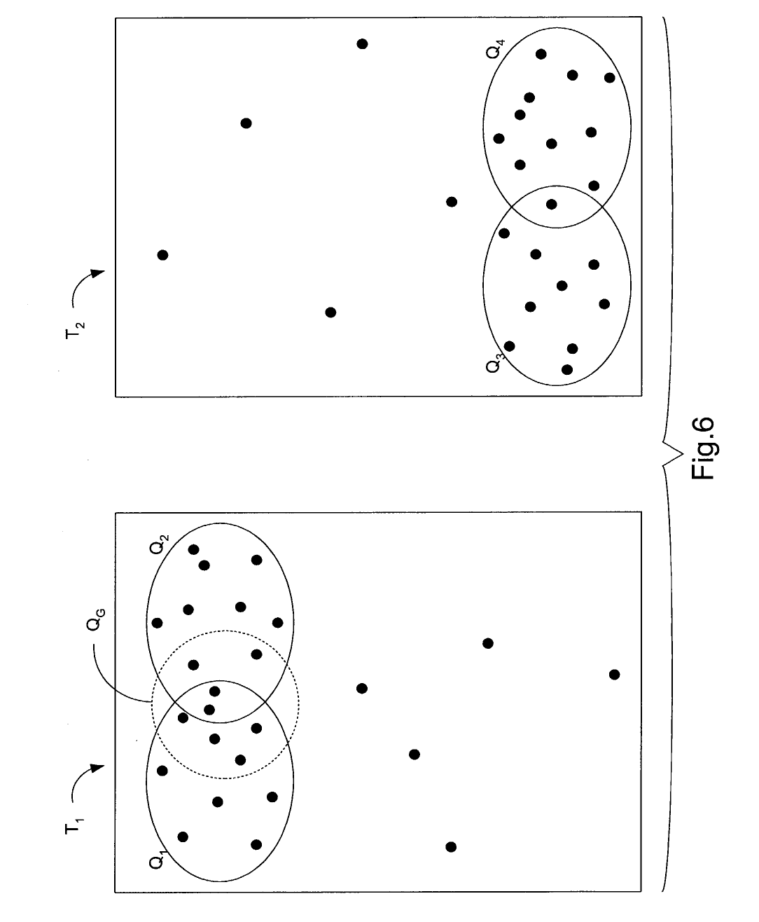

FIG. 6 illustrates sample tables that may be constructed by the disclosed method for a given workload including queries Q₁, Q₂, Q₃ and Q₄. The disclosed method may divide the given workload into a first partition that includes queries Q₁ and Q₂ and a second partition that includes queries Q₃ and Q₄. The method may then construct sample tables T₁ and T₂, where T₁ samples heavily from records that would be accessed by queries Q₁ and Q₂ and T₂ samples heavily from records that would be accessed by queries Q₃ and Q₄. The method may then identify table T₁ as the most appropriate sample table for a given query Q_{G}. The given query would then be rewritten and executed on table T₁ to approximate the result of the given query Q_{G}. By sampling from “hot areas” for queries that are similar to the given query, the accuracy of the approximation is improved.

### PREPROCESSING COMPONENT

In the exemplary embodiment, the workload is partitioned 120, the database is stratified 135 for each partition and multiple sample tables are built 140 by the preprocessing component. Referring to FIG. 7, an appropriate maximum size for each sample size is determined 102 by the preprocessing module or may be predetermined. The maximum sample table size is used to determine 104 the number of sample tables. The given workload is divided 120 into a number of workload partitions that corresponds to the number of sample tables. In the exemplary embodiment, a centroid query is calculated 130 for each workload partition. The database table is stratified 135 into regions of varying importance to a workload partition for each workload partition. A set of sample tables that correspond to the partitions are constructed 140.

Workload Partition

In the exemplary embodiment, the workload is divided 120 into two or more workload partitions. Each workload partition contains queries that are very similar to each other. When a workload is partitioned such that each partition contains similar queries, a separate sample table built for each partition is better tuned for queries that are similar to the queries in that partition. FIG. 6 illustrates that a sample table built for a workload partition that includes queries Q₁ and Q₂ is better tuned for queries that are similar to queries Q₁ and Q₂.

In the exemplary embodiment, a similarity measure between queries is used to cluster similar queries into different workload partitions. In one embodiment, the similarity measure measures how many GROUP-BY columns are common between the two queries. In an alternate embodiment, the similarity measure compares an overlap of WHERE clauses in the workload queries to determine the similarity between the queries.

In the exemplary embodiment, a clustering algorithm uses the similarity measure to partition the workload. One clustering algorithm that can be used to partition the workload is disclosed in Compressing SQL Workloads. Surajit Chaudhuri, Ashish Gupta, Vivek Narasayya. SIGMOD 2002. It should be readily apparent to those skilled in the art that any clustering algorithm could be adapted to cluster similar queries to partition the workload. For example, k-means clustering could be used to cluster similar queries to partition the workload.

Example of Similarity Measure Between GROUP BY Queries

Four queries may include the following GROUP BY clauses:

(1) GROUP BY A, B, C, D

(2) GROUP BY B, C, D, E

(3) GROUP BY W, X, Y, Z

(4) GROUP BY V, W, X, Y

The disclosed method would consider the first and second queries similar to each other, because the GROUP BY columns B, C and D overlap. Similarly, the method would consider the second and third queries similar to each other, because the GROUP BY columns W, X and Y overlap. The disclosed method would not consider the first or second query similar to the third or fourth query, because none of the GROUP BY columns overlap. In one embodiment, the disclosed method determines the similarity of queries based on the overlap of columns in WHERE clauses of queries.

Queries may reference columns that occur in more than one table in the database when the tables of the database can be joined using foreign keys. In one embodiment, the disclosed method determines the similarity of queries based on an overlap of columns referenced by queries that select from multiple tables that are joined by foreign keys.

In one embodiment, the number of partitions is determined by dividing the total space allocated for sample tables by the maximum size of each sample table. The maximum size of each sample table is determined by an upper limit on query execution time. Workload partitioning is efficient as its running time depends only on the workload size, and is independent of the actual data.

Database Stratification

In the exemplary embodiment, the database tables are stratified into regions of varying importance for each workload partition and each database fact table. Stratified sampling involves selecting samples uniformly from each region, with “important” regions contributing relatively more samples. Regions of higher importance include records that are accessed by queries in the workload partition more often.

One method for stratifying database tables into regions of varying importance for a given workload is disclosed by the '960 application. In one embodiment of the method disclosed by the '960 application, the database tables are partitioned into regions by grouping data records such that no query in the given workload selects a proper subset of any region. Importance of a given region can be measured by the number of queries that select the given region and/or the number of queries in a region. The details of this stratification method are disclosed in the '960 application.

The method disclosed by the '960 application can be used stratify the database tables into regions of varying importance for each workload partition by treating each workload partition as a workload. However, it should be readily apparent to those skilled in the art that any method for stratifying the database could be employed. The efficiency of database stratification depends on the time taken to execute a small number of representative workload queries against the database.

Building Sample Tables

For each workload partition and corresponding stratified database table 61, the disclosed method builds 140 a sample table 62. The samples in each sample table 62 are allocated according to the importance of the regions of the stratified database tables 61. The allocation mechanism determines how different regions get different number of samples. The allocation mechanism solves an optimization problem whose objective is to minimize the average error over all queries in the workload partition. One method for building a sample table to minimize the average error over all queries in a workload is disclosed in the '960 patent and selects samples from the stratified regions in a manner that minimizes estimation error over the expected workload. Details of this method of building a sample table are disclosed in the '960 application. The method disclosed by the '960 patent can be used to build a sample table for each workload partition. In the exemplary embodiment, each workload partition is treated as the workload for the method disclosed by the '960 patent builds a sample table for.

In the exemplary embodiment, the disclosed method keeps a condensed version of the queries that appear in each workload partition along with each sample table. In one embodiment, a centroid query or a portion of a centroid query could be calculated 130 and retained for each workload partition that results from the clustering algorithm. For example, the set of GROUP-BY columns of the centroid query of each partition that results from the clustering algorithm could be retained. This information is used at runtime to match an incoming query to the most appropriate sample table.

The time required for building sample tables is proportional to a single database scan.

### QUERY PROCESSING COMPONENT

In a query processing component, an incoming or given query is matched to a most appropriate sample table, rewritten and executed on the most appropriate sample table. Referring to FIG. 8, the query processing module 150 compares 155 a given query to the centroid queries of the workload partitions in the exemplary embodiment. A most appropriate sample table is selected 160 that corresponds to a workload partition that has a centroid query that is most similar to the given query Q_{G}. The given query is rewritten 170 for the most appropriate sample table. In the exemplary embodiment, references in the given query to the database table are replaced with references to the most appropriate sample table and aggregate expressions in the given query are scaled. The query is executed 180 on the most appropriate sample table.

Matching Incoming Query to Most Appropriate Sample Table

An incoming query is matched 160 to the most appropriate sample table to be used for execution. In the exemplary embodiment, the most appropriate sample table is the table that was created with the workload partition that included queries that were most similar to the incoming query. In the exemplary embodiment, the most appropriate sample table is computed to be the table whose corresponding workload partition's centroid query is most similar to the incoming query. In the exemplary embodiment, the similarity measure used to match an incoming query to the most appropriate sample table is the same similarity measure used to partition the workload. It has been observed that this matching step is fast since the similarity computation between the incoming query and all the centroids of the various partitions does not need to access the actual data in the database.

Rewriting and Executing the Query

In the exemplary embodiment, an incoming query Q_{G} is rewritten 170 for execution on the most appropriate sample table instead of the database table(s). In the exemplary embodiment, a given or incoming query is rewritten as follows. First, all references to the original database table(s) are replaced with references to the most appropriate sample table. Then, all aggregate expressions are appropriately scaled. Finally, SQL code is inserted to compute error estimates of the answers (i.e. confidence intervals), and the query is executed. The running time depends on the size of the sample table.

### EXAMPLES OF EXPERIMENTAL IMPLEMENTATION

The disclosed method has been effectively used on a portion of a large sales database. The database used in the experiment had a main fact table of 0.85 million rows, and 11 dimension tables, ranging from a few hundred rows to around 0.2 million rows each. Forty-four actual sales queries were collected as the experimental workload. These queries were complicated Select-Project-Join queries with aggregations and group-bys. A typical query involved the join of 8-10 tables, 10-15 group-by columns, and had complex selection conditions.

The workload was divided into two parts: 10 queries were removed at random to form the test workload, and the remaining 34 queries formed a training workload. For the test system, it was assumed that the total space availability for sample tables was 15% of the fact table. Each individual sample table was restricted to be 1% of the fact table. The system was trained with the training workload. Both the quality and performance of the disclosed method was compared to a 1% uniform random sample.

The results of two queries, Q_{A} and Q_{B} are described. Q_{A} is a query from the training workload, and Q_{B} is a query from the test workload. When executed without any approximations, Q_{A} resulted in 2612 groups. Uniform random sampling only produced 525 groups, out of which the aggregates were acceptably accurate for only a few of the largest groups. On the other hand, the disclosed method produced 2602 groups, and the aggregates were accurate for many of these groups.

The query Q_{B} is a true ad-hoc query, i.e. it has not been seen by the system at all. When executed without any approximations, Q₂ resulted in 2582 groups. Uniform random sampling only produced 274 groups, out of which the aggregates were acceptably accurate for only a few of the largest groups. The disclosed method produced 1116 groups, and the aggregates were accurate for many of these groups.

While the exemplary embodiments of the invention have been described with a degree of particularity, it is the intent that the invention include all modifications and alterations from the disclosed design falling within the spirit or scope of the appended claims.

We claim:

1. A method for estimating the result of an aggregation query on a database wherein the database has data records arranged in one or more database tables, and wherein the database has a given workload comprising a set of queries, the method comprising:
a) dividing said given workload into a set of workload partitions including queries from said workload;
b) constructing a set of sample tables wherein samples of each sample table are selected to reduce an estimation error for one of said workload partitions;
c) identifying a most appropriate sample table in said set of sample tables for a given aggregate query;
d) executing the given aggregate query on the most appropriate sample table; and
e) returning an estimated result for the given aggregate query.

2. The method of claim 1 further comprising measuring a similarity between queries in said workload and said workload is divided based on the similarity between queries.

3. The method of claim 2 wherein said similarity between queries corresponds to a similarity of WHERE clauses in said queries.

4. The method of claim 3 wherein the one or more database tables have multiple columns and the similarity is a comparison of an overlap of WHERE clauses.

5. The method of claim 2 wherein said similarity between queries corresponds to a similarity of GROUP-BY columns in said queries.

6. The method of claim 5 wherein the one or more database tables have multiple columns and the similarity is a comparison of an overlap of GROUP-BY expressions.

7. The method of claim 1 wherein constructing said set of sample tables comprises stratifying said database table into regions of varying importance to a partition of queries for each partition in said set of partitions and wherein each sample table in the set corresponds to a partition and samples in each sample table are allocated according to an importance to the workload partition.

8. The method of claim 1 further comprising calculating a centroid query for each workload partition, comparing the given query to centroid queries of the workload partitions and identifying the sample table as the most appropriate sample table that corresponds to a workload partition having a centroid query that is most similar to said given query.

9. The method of claim 1 further comprising rewriting said given query for execution on the most appropriate sample table.

10. The method of claim 9 wherein rewriting comprises replacing references in the given query to the one or more database tables with references to the most appropriate sample table and scaling aggregate expressions in said given query.

11. The method of claim 1 further comprising determining a maximum size for said sample tables based on an upper limit on approximated query execution time.

12. The method of claim 11 further comprising determining an appropriate number of sample tables by dividing a total space allocated for the sample tables by said maximum size.

13. A method for estimating the result of an aggregation query on a database wherein the database has data records arranged in a database table, and wherein the database has a given workload comprising a set of queries, the method comprising:
a) dividing said workload into a set of workload partitions including queries from said workload;
b) stratifying said database into regions of importance to the workload partitions in said set of partitions;
c) constructing a set of sample tables wherein a sample table corresponds to a workload partition and samples in the sample table are allocated according to an importance of a region of said database that corresponds the sample table;
d) identifying a most appropriate sample table in said set of sample tables for a given incoming query;
e) executing the given query on the most appropriate sample table.

14. The method of claim 13 further comprising measuring a similarity between queries in said workload and said workload is divided based on the similarity between queries.

15. The method of claim 14 wherein said similarity between queries corresponds to a similarity of WHERE clauses in said queries.

16. The method of claim 15 wherein the one or more database tables have multiple columns and the similarity is a comparison of an overlap of WHERE clauses.

17. The method of claim 14 wherein said similarity between queries corresponds to a similarity of GROUP-BY columns in said queries.

18. The method of claim 17 wherein the one or more database tables have multiple columns and the similarity is a comparison of an overlap of GROUP-BY expressions.

19. The method of claim 13 further comprising calculating a centroid query for each workload partition, comparing the given query to centroid queries of the workload partitions and selecting the sample table that corresponds to a workload partition having a centroid query that is most similar to said given query.

20. The method of claim 13 further comprising rewriting said given query for execution on the most appropriate sample table.

21. The method of claim 20 wherein rewriting comprises replacing references in the given query to the one or more database tables with references to the most appropriate sample table and scaling aggregate expressions in said given query.

22. The method of claim 13 further comprising determining a maximum size for said sample tables based on an upper limit on approximated query execution time.

23. The method of claim 22 further comprising determining an appropriate number of sample tables by dividing the total space allocated for sample tables b.

24. A method for estimating the result of an aggregation query on a database wherein the database has data records arranged in one or more database tables, and wherein the database has a given workload comprising a set of queries, the method comprising:
a) determining an appropriate number of sample tables;
b) determining an appropriate size for said sample tables;
c) dividing said given workload into a number of workload partitions that corresponds to the appropriate number of sample tables, said workload being divided based on a similarity between queries in said workload;
d) calculating a centroid query for each workload partition;
e) stratifying said database into regions of varying importance to a workload partition for each partition in said set of partitions;
f) constructing a set of sample tables wherein a sample table corresponds to a partition and samples in the sample table are allocated according to importance of a region of said one or more database tables to the partition that corresponds the sample table;
g) comparing a given query to the centroid queries of the partitions;
h) selecting a most appropriate sample table that corresponds to a partition having a centroid query that is most similar to said given query;
i) replacing references in the given query to the database table with references to the most appropriate sample table;
j) scaling aggregate expressions in said given query; and
k) executing the query on the most appropriate sample table.

25. A computer readable medium having computer executable instructions stored thereon for performing a method for estimating the result of an aggregation query on a database wherein the database has data records arranged in one or more database tables, and wherein the database has a given workload comprising a set of queries, the method comprising:
a) dividing said given workload into a set of workload partitions including queries from said workload;
b) constructing a set of sample tables wherein samples of each sample table are selected to reduce an estimation error for one of said partitions of queries;
c) identifying a most appropriate sample table in said set of sample tables for a given query;
d) executing the given query on the most appropriate sample table; and
e) returning an estimated result for the given query.

26. The computer readable medium of claim 25 further comprising measuring a similarity between queries in said workload and said workload is divided based on the similarity between queries.

27. The computer readable medium of claim 26 wherein said similarity between queries corresponds to a similarity of WHERE clauses in said queries.

28. The computer readable medium of claim 27 wherein the one or more database tables have multiple columns and the similarity is a comparison of an overlap of columns specified in WHERE clauses.

29. The computer readable medium of claim 26 wherein said similarity between queries corresponds to a similarity of GROUP-BY columns in said queries.

30. The computer readable medium of claim 29 wherein the one or more database tables have multiple columns and the similarity is a comparison of an overlap of columns specified in GROUP-BY expressions.

31. The computer readable medium of claim 25 wherein constructing said set of sample tables comprises stratifying said database table into regions of varying importance to a partition of queries for each partition in said set of partitions and wherein each sample table in the set corresponds to a partition and samples in each sample table are allocated according to an importance to the workload partition.

32. The computer readable medium of claim 25 further comprising calculating a centroid query for each workload partition, comparing the given query to centroid queries of the workload partitions and identifying the sample table as the most appropriate sample table that corresponds to a workload partition having a centroid query that is most similar to said given query.

33. The computer readable medium of claim 25 further comprising rewriting said given query for execution on the most appropriate sample table.

34. The computer readable medium of claim 33 wherein rewriting comprises replacing references in the given query to the one or more database tables with references to the most appropriate sample table and scaling aggregate expressions in said given query.

35. The computer readable medium of claim 25 further comprising determining an appropriate size for said sample tables.

36. The computer readable medium of claim 25 further comprising determining an appropriate number of sample tables.

37. A computer readable medium having computer executable instructions stored thereon for performing a method for estimating the result of an aggregation query on a database wherein the database has data records arranged in one or more database tables, and wherein the database has a given workload comprising a set of queries, the method comprising:
a) dividing said workload into a set of workload partitions including queries from said workload;
b) stratifying said database into regions of importance to the workload partitions in said set of partitions;
c) constructing a set of sample tables wherein a sample table corresponds to a workload partition and samples in the sample table are allocated according to an importance of a region of said database that corresponds the sample table;
d) identifying a most appropriate sample table in said set of sample tables for a given incoming query;
e) executing the given query on the most appropriate sample table.

38. The computer readable medium of claim 37 further comprising measuring a similarity between queries in said workload and said workload is divided based on the similarity between queries.

39. The computer readable medium of claim 38 wherein said similarity between queries corresponds to a similarity of WHERE clauses in said queries.

40. The computer readable medium of claim 39 wherein the one or more database tables have multiple columns and the similarity is a comparison of an overlap of WHERE clauses.

41. The computer readable medium of claim 38 wherein said similarity between queries corresponds to a similarity of GROUP-BY columns in said queries.

42. The computer readable medium of claim 41 wherein the one or more database tables have multiple columns and the similarity is a comparison of an overlap of GROUP-BY expressions.

43. The computer readable medium of claim 37 further comprising calculating a centroid query for each workload partition, comparing the given query to centroid queries of the workload partitions and selecting the sample table that corresponds to a workload partition having a centroid query that is most similar to said given query.

44. The computer readable medium of claim 37 further comprising rewriting said given query for execution on the most appropriate sample table.

45. The computer readable medium of claim 44 wherein rewriting comprises replacing references in the given query to the one or more database tables with references to the most appropriate sample table and scaling aggregate expressions in said given query.

46. The computer readable medium of claim 37 further comprising determining an appropriate size for said sample tables based on an upper limit on approximated query execution time.

47. The computer readable medium of claim 46 further comprising determining an appropriate number of sample tables by dividing the total space allocated for sample tables by said appropriate size.

48. A method for estimating the result of an aggregation query on a database wherein the database has data records arranged in one or more database tables, and wherein the database has a given workload comprising a set of queries, the method comprising:
a) determining an appropriate number of sample tables;
b) determining an appropriate size for said sample tables;
c) dividing said given workload into a number of workload partitions that corresponds to the appropriate number of sample tables, said workload being divided based on a similarity between queries in said workload;
d) calculating a centroid query for each workload partition;
e) stratifying said database table into regions of varying importance to a workload partition for each partition in said set of partitions;
f) constructing a set of sample tables wherein a sample table corresponds to a partition and samples in the sample table are allocated according to importance of a region of said one or more database tables to the partition that corresponds the sample table;
g) comparing a given query to the centroid queries of the partitions;
h) selecting a most appropriate sample table that corresponds to a partition having a centroid query that is most similar to said given query;
i) replacing references in the given query to the database table with references to the most appropriate sample table;
j) scaling aggregate expressions in said given query; and
k) executing the query on the most appropriate sample table.
